(19) United States
(12) Patent Application Publication
(10) Pub. No.: US 2009/0314222 A1
(43) Pub. Date: Dec. 24, 2009

(54) Pet toy

(76) Inventors: Nathan S. Chefetz, Washington, DC (US); Cade H. Goldenberg, Rye Brook, NY (US)

Correspondence Address: Michael J. Foycik, Jr., 4235 University Drive, Fairfax, VA, 22030, US

(21) Appl. No.: 12/213,698

(22) Filed: Jun. 23, 2008

(51) Int. Cl. A01K 29/00

(52) U.S. Cl. 119/707

(57) ABSTRACT

An improved pet toy has a toy body composed of polyolefin having good flexibility and resiliency, which is an ethylene vinylacetate copolymer. The pet toy can be cylindrical in shape, toroidal in shape, spherical in shape, or can have a saucer-shape having an aerodynamic form for gliding.

### BACKGROUND OF THE INVENTION

1. Technical Field

This invention relates generally to pet toys. In particular, it relates to a material especially useful for dog toys.

2. Description of Related Art

Pet toys are generally well known. Such pet toys can include simulated bones for dogs, chew toys for dogs or cats, and ring toys of various kinds. Some kinds of pet toys are chewable and edible, or are chewable but not edible.

An important characteristic of any dog toy is its attractiveness to a dog, how interesting the toy is to the dog over a relatively long period of time, and how long the dog toy lasts in use.

It is accordingly a problem in the prior art to provide a pet toy that is attractive to a pet, that has lasting play value to the pet, and that is durable in use.

It is especially important for dog toys to be durable, that is, to last and retain their shape after repeated chewings by a dog, since many dogs have very strong jaw muscles and teeth.

### SUMMARY OF THE INVENTION

From the foregoing, it is seen that it is a problem in the art to provide a device meeting the above requirements. According to the present invention, a device and process are provided which meets the aforementioned requirements and needs in the prior art. Specifically, the device according to the present invention provides a pet toy that is attractive to a pet, that has lasting play value to the pet, and that is durable in use.

More specifically, the present invention provides an improved dog toy that is durable, that lasts and retains its shape after repeated chewings by a dog, since many dogs have very strong jaw muscles and teeth.

The pet toy according to the present invention has any one of various shapes made from a foamed thermoplastic high grade synthetic material, utilizing FDA approved resins, oils and food grade silicone. The preferred material used in the present invention is that shown and described in U.S. Pat. No. 4,363,849 to Paisley et al. When molded, the thermoplastic has good strength and stiffness and other physical properties. The toy is lightweight and retains its shape after a dog compresses its teeth and jaw into the toy. The toy is odorless, tasteless and floats in water. The toy allows tooth punctures and is highly durable. The toy is made of properties that allow it to be recyclable. The toy can be created with any color throughout the outside and core.

The toy is modeled after synthetic wine corks. The toy benefits are unlike the competition. The foamed thermoplastic material is ultra lightweight and can be injected into any shape or size suitable for a dog toy and entertainment. There is no chemical scent and it is completely odorless and tasteless which is appealing to dogs. It is easy to carry in a dog's mouth and isn't heavy in weight straining the jaw and neck of a dog when carrying. The dog toy floats which makes for great water entertainment. Various colors may be added for visual appeal. Dogs large and small may attempt to chew the toy when playing and the toy allows for multiple tooth punctures but retains most of or all of the original shape. Dogs find the toy appealing because of the ability to carry a lightweight material in any shape, puncture and bite into their toy without the chemical scent or taste of the prior dog toys. The material can also be scent or flavor injected in order to mimic food or other natural objects such as a bird. The toy's properties also allow it to bounce. Additionally, the pet toy acts to massage the teeth and gums of a pet, especially a dog, increasing the dog's enjoyment of the pet toy and thus results in relatively long chewing times.

Other objects and advantages of the present invention will be more readily apparent from the following detailed description when read in conjunction with the accompanying drawings.

### BRIEF DESCRIPTION OF THE DRAWINGS

FIG. 1 is a perspective view of a pet toy formed of improved material in accordance with the present invention.

FIG. 2 is top elevational view of a torus-shaped pet toy formed of improved material in accordance with the present invention.

FIG. 3 is a top elevational view of a cylindrical pet toy formed of improved material and having a novel internal structure in accordance with the present invention.

FIG. 4 is a sectional view of the improved pet toy of FIG. 3, taken along line 4-4 of FIG. 3.

FIG. 5 is a sectional view of the improved pet toy of FIG. 3, taken along line 5-5 of FIG. 3.

### DETAILED DESCRIPTION

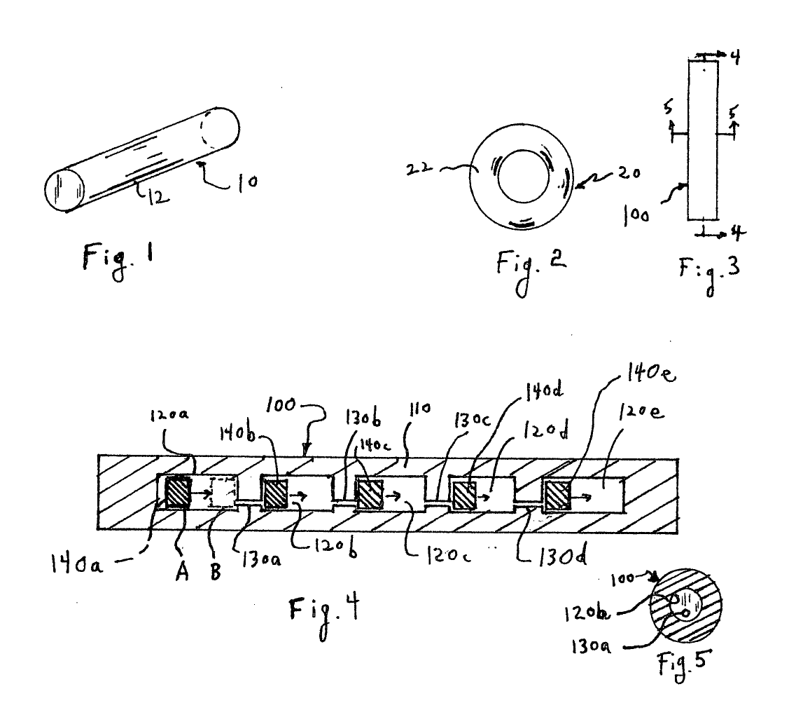

FIG. 1 is a perspective view of a generally cylinder-shaped pet toy 10 having a solid body 12 formed of an improved material, as discussed further hereunder.

The improved material of the body 12 is the preferred material to be used in the present invention, and is shown and described in U.S. Pat. No. 4,363,849 to Paisley et al., the entire disclosure of which is hereby expressly incorporated herein by reference thereto. In particular, the improved material is of the type described to make a cork-like material described in the Paisley et al. patent referenced hereinabove, at column 5 line 34 through column 6 line 59 thereof. The material is also available under the commercial name Beltappo® by the company of the same name.

A portion of the above-referenced Paisley et al. patent states that “The basic resinous materials utilized is preferably a polyolefin having good flexibility and resiliency such as ethylene vinylacetate copolymer (EVA). To achieve the exact combination of properties desired in the finished articles, it is necessary to choose an EVA material based on the percentage of vinylacetate (% VA) incorporated into the copolymer and the melt index of the resin. Typically usable resin grades vary between 9 and 25% by weight VA and between 2.0 and 8.0 in melt index and are available from a number of sources. The properties of the finished closures may be enhanced by the addition to the basic resin of small quantities of a hardness modifying additive, such as polyethylene or tonically cross-linked ethylene methacrylic acid copolymers. The addition of such hardness modifying additives, such as polyethylene or ionically cross-linked ethylene methacrylic acid copolymers, tends to vary the hardness and strength of the finished article. To the basic resin or mixture of resins is added a suitable chemical blowing agent to expand the resin to proper density. The preferred blowing agent is azodicarbonamide (ABFA) because of its decomposition temperature which is in the normal processing range of EVA resin and because of its relatively high rate of gas evolution.”

While a cylindrical shape is provided for the pet toy 10 of FIG. 1, other shapes can be provided formed of the above-described improved material, such as ball, a donut, a saucer-shaped throwing and gliding toy, and a bone, for example. The improvement therein is the use of a material with especial advantages in the dog toy art, the material having been used only in the cork arts prior hereto.

More specifically, the present invention provides an improved dog toy 10 that is durable, and that lasts and retains its shape after repeated chewings by a dog, since many dogs have very strong jaw muscles and teeth.

The pet toy 10 has any one of various shapes as noted above, made from a foamed thermoplastic high grade synthetic material as described hereinabove, utilizing FDA approved resins, oils and food grade silicone. The preferred material preferably used in the present invention for the dog toy 10 is that shown and described in the above-referenced U.S. Pat. No. 4,363,849 to Paisley et al. When molded, the thermoplastic has good strength and stiffness and other physical properties. The toy is lightweight and retains its shape after a dog compresses its teeth and jaw into the toy. The toy is odorless, tasteless and floats in water. The toy allows tooth punctures and is highly durable. The toy is made of properties that allow it to be recyclable. The toy can be created with any color throughout the outside and core.

The toy is modeled after synthetic wine corks. The toy benefits are unlike the prior art pet toys. The foamed thermoplastic material is ultra lightweight and can be injected into any shape or size suitable for a dog toy and entertainment. There is no chemical scent and it is completely odorless and tasteless, which qualities are appealing to dogs. It is easy to carry in a dog's mouth and isn't heavy in weight which would otherwise be straining the jaw and neck of a dog when carrying. The dog toy floats which makes for great water entertainment. Various colors may be added for visual appeal. Dogs large and small may attempt to chew the toy when playing and the toy allows for multiple tooth punctures but retains most of or all of the original shape. Dogs find the toy 10 appealing because of the ability to carry a lightweight material in any shape, puncture and bite into their toy without the chemical scent or taste of the prior dog toys. The material can also be scent- or flavor-injected in order to mimic food or other natural objects such as a bird. The toy's properties also allow it to bounce. Additionally, the pet toy 10 acts to massage the teeth and gums of a pet, especially a dog, increasing the dog's enjoyment of the pet toy 10 and thus results in relatively long chewing times.

FIG. 2 is top elevational view of a torus-shaped pet toy 20 having a body 22 formed of the improved material described hereinabove with reference to FIG. 1.

FIG. 3 is a top elevational view of a cylindrical pet toy 100 formed of the improved material described hereinabove with reference to FIGS. 1 and 2, and having a novel internal structure as shown in FIGS. 4 and 5 described below.

FIG. 4 is a sectional view of the improved pet toy 100 of FIG. 3, taken along line 4-4 of FIG. 3. The pet toy 100 has a body portion 110 shown in section in this view. The body portion includes a plurality of compartments 120a, 120b, 120c, 120d, and 120e in communication with each other via a plurality of connecting passages 130a, 130b, 130c, and 130d. A plurality of movable elements 140a, 140b, 140c, 140d, and 140e are disposed in respective ones of the aforesaid plurality of compartments. In use, when a dog bites down on the toy 100, air pressure is altered within the chambers 120a-120e, and. depending upon where the dog is biting along the length of the body portion 110, different ones of the movable elements 140a-140e are moved within their respective chambers 120a-120e. In FIG. 4, this movement is indicated by the arrows labeled A and B, in which label A indicates a first position of the element 120a within the compartment 140a, while label B indicates a position of the element 120a (shown in dashed outline) at a second position.

When a dog bites on the toy 100, as explained above, the movable elements 140a-140e move to various positions depending upon where the dog has bitten the body portion 110. This movement creates a noise audible to a dog's ears, including a sliding sound and also a slight popping sound which can simulate the sound of small bones cracking or popping. Additionally, since the chambers 120a-120e are connected by the passages 130a-130d, upon release of pressure (i.e. when the dog drops the toy 100) there is air pressure of varying levels in the chambers 120a-120e (depending upon where the dog was biting on the body portion 110 and how hard the dog was biting), so that some or all of the movable elements 120a-120e are caused to move as the air pressure becomes equalized within the chambers 120a-120e. This causes noises which can include sliding noises and popping noises, which are intended to trigger a renewed interest by the dog in the toy 100.

FIG. 5 is a sectional view of the improved pet toy 100 of FIG. 3, taken along line 5-5 of FIG. 3. In this view, one chamber 120b is visible, as is the passageway 130a.

It is to be understood that the present invention is not limited to the embodiments described above, but encompasses any and all embodiments with the scope of the following claims.

1. An improved pet toy, comprising:
a toy body composed of polyolefin having good flexibility and resiliency, which is an ethylene vinylacetate copolymer.

2. The improved pet toy of claim 1, where said toy body is cylindrical in shape.

3. The improved pet toy of claim 1, where said toy body is toroidal in shape.

4. The improved pet toy of claim 1, where said toy body is spherical in shape.

5. The improved pet toy of claim 1, where said toy body is saucer-shaped having an aerodynamic form for gliding.

6. The improved pet toy of claim 1, where said toy body is generally cylindrical in shape, and has a body portion which includes a plurality of compartments in communication with each other via a plurality of connecting passages; and further comprising a plurality of movable elements disposed in respective ones of said plurality of compartments;
whereby in use, when a pet bites down on the toy body, air pressure is altered within the chambers, and depending upon where the pet is biting along the length of the body portion, different ones of the movable elements are moved within their respective chambers, creating sounds that can be heard by the pet.

7. An improved pet toy, comprising:
a toy body consisting of polyolefin having good flexibility and resiliency, which is an ethylene vinylacetate copolymer.
